(19) United States
(12) Patent Application Publication
(10) Pub. No.: US 2009/0211285 A1
(43) Pub. Date: Aug. 27, 2009

(54) Condensing Unit

(76) Inventor: Benjamin P. Picker, Tipp City, OH (US)

Correspondence Address: HARNESS, DICKEY & PIERCE, P.L.C., P.O. BOX 828, BLOOMFIELD HILLS, MI, 48303, US

(21) Appl. No.: 12/390,927

(22) Filed: Feb. 23, 2009

Related U.S. Application Data
(60) Provisional application No. 61/031,521, filed on Feb. 26, 2008.

(51) Int. Cl. F25D 23/12; B23P 11/02

(52) U.S. Cl. 62/259.1; 29/453

(57) ABSTRACT

A condensing unit is provided and may include a support base having a first retention feature and a second retention feature and a shroud having a first locking feature receiving one of the first retention feature and the second retention feature to automatically attach the shroud to the support base when the shroud is moved a first predetermined distance relative to the support base. A heat exchanger may include at least one second locking feature receiving the other of the first locking feature and the second locking feature to automatically attach the heat exchanger to the support base when the heat exchanger is moved a second predetermined distance relative to the support base.

### CROSS-REFERENCE TO RELATED APPLICATIONS

This application claims the benefit of U.S. Provisional Application No. 61/031,521, filed on Feb. 26, 2008. The entire disclosure of the above application is incorporated herein by reference.

### FIELD

The present disclosure relates to condensing units and more particularly to a support structure for a condensing unit.

### BACKGROUND

The statements in this section merely provide background information related to the present disclosure and may not constitute prior art. Refrigeration systems typically include a compressor, a condenser, and an evaporator fluidly coupled to produce a cooling and/or heating effect. In such a system, the compressor and condenser may be positioned in close proximity to each other to facilitate packaging of the refrigeration system and to reduce the overall size of the system.

### SUMMARY

A condensing unit is provided and may include a support base having a first retention feature and a second retention feature and a shroud having a first locking feature receiving one of the first retention feature and the second retention feature to automatically attach the shroud to the support base when the shroud is moved a first predetermined distance relative to the support base. A heat exchanger may include at least one second locking feature receiving the other of the first locking feature and the second locking feature to automatically attach the heat exchanger to the support base when the heat exchanger is moved a second predetermined distance relative to the support base.

At least one of the first retention feature and the second retention feature may include a locking tab.

At least one of the first retention feature and the second retention feature may be integrally formed with the support base.

At least one of the first retention feature and the second retention feature may be formed from the same material as the support base.

At least one of the first retention feature and the second retention feature may be formed from a flexible material and may be movable between a relaxed state and an engaged state in response to at least one of movement of the shroud the first predetermined distance relative to the support base or movement of the heat exchanger the second predetermined distance relative to the support base.

Engagement between at least one of the first retention feature and the first locking feature and engagement between the second retention feature and the second locking feature may include a snap fit.

The support base may include a third retention feature. The heat exchanger may include a third locking feature that engages the third retention feature when the heat exchanger is moved the second predetermined distance relative to the support base to secure the heat exchanger to the support base.

At least one of the second retention feature and the third retention feature may be in slidable engagement with the second locking feature and the third locking feature, respectively.

The heat exchanger may be a condenser.

The first predetermined distance may be approximately the same as the second predetermined distance.

In another configuration, a condensing unit is provided and may include a support base having a first retention feature and a second retention feature and a shroud having a first locking feature receiving the first retention feature in a snap-fit engagement to attach the shroud to the support base. A heat exchanger may include at least one second locking feature receiving the second retention feature in a snap-fit engagement to attach the heat exchanger to the support base.

The support base may include a third retention feature and the heat exchanger may include a third locking feature, whereby the third retention feature engages the third locking feature when the second locking feature receives the second retention feature to position the heat exchanger relative to the support base. The third locking feature may be in slidable engagement with the third retention feature.

At least one of the first retention feature and the second retention feature may be integrally formed with the support base.

At least one of the first retention feature and the second retention feature may be formed of the same material.

At least one of the first retention feature and the second retention feature may be formed from a flexible material and may be movable between a relaxed state and an engaged state in response to at least one of movement of the shroud or movement of the heat exchanger a predetermined distance relative to the support base.

The heat exchanger may be a condenser.

The heat exchanger may include a retention element that engages a retention element of the shroud to attach the shroud to the heat exchanger.

A method is provided and may include positioning a shroud relative to a support base and moving the shroud relative to the support base until a first locking feature of the shroud engages a first retention feature of the support base to attach the shroud to the support base. The method may further include positioning a heat exchanger relative to the support base and moving the heat exchanger relative to the support base until a second locking feature of the heat exchanger engages a second retention feature of the support base to attach the heat exchanger to the support base.

At least one of the moving the shroud and the moving the heat exchanger may include sliding.

Engaging the first retention feature and engaging the second retention feature may include bending at least one of the first retention feature and the second retention feature relative to the support base.

Engaging the first retention feature and engaging the second retention feature may include creating a snap-fit relationship between at least one of the first retention feature and the first locking feature and between the second retention feature and the second locking feature.

Engaging the first retention feature and engaging the second retention feature may include at least one of engaging a locking tab of the first retention feature with the first locking feature and engaging a locking tab of the second retention feature with the second locking feature.

The method may also include engaging a third retention feature of the support base with a third retention feature of the heat exchanger.

Engaging the third retention feature with the third locking feature may include sliding the third locking feature relative to the third retention feature.

The method may further include attaching the shroud to the heat exchanger prior to either of the shroud or the heat exchanger being attached to the support base.

The method may further include attaching the shroud to the heat exchanger after at least one of the shroud and the heat exchanger are attached to the support base.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a condensing unit in accordance with the principles of the present disclosure;

FIG. 2 is an exploded front perspective view of the condensing unit of FIG. 1;

FIG. 3 is an exploded rear perspective view of the condensing unit of FIG. 1;

FIG. 4 is a top view of a support base for use with the condensing unit of FIG. 1;

FIG. 5 is a side view of a support base for use with the condensing unit of FIG. 1;

FIG. 6 is a partial perspective view of the support base of FIG. 4;

FIG. 7 is a partial perspective view of the support base of FIG. 4 showing a condenser assembly attached to the support base;

FIG. 8 is a partial cross-sectional view of the support base of FIG. 4; and

FIG. 9 is a perspective view of a shroud according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

With reference to the figures, a condensing unit 10 is provided and may include a condenser assembly 12, a fan assembly 14, a compressor assembly 16, and a support base 18. Each of the condenser assembly 12, fan assembly 14, and compressor assembly 16 may be fixedly attached to the support base 18 to allow the condenser assembly 12, fan assembly 14, and compressor assembly 16 to be transported and installed as a single unit.

The condenser assembly 12 may include a heat exchanger such as, for example, a coil 20 and a housing 22 generally surrounding at least a portion of the coil 20. The coil 20 may include a tube 24 having a series of bends 26, an inlet 28, and an outlet 30. The bends 26 may extend at least partially from the housing 22 to facilitate heat transfer between the tube 24 and ambient air generally surrounding the condensing unit 10. The inlet 28 may be fluidly coupled to an outlet of the compressor assembly 16 to receive a high-pressure vapor from the compressor assembly 16 while the outlet 30 may be fluidly coupled to an expansion device and an external heat exchanger such as, for example, an evaporator (neither shown) to provide the evaporator with fluid in a liquid state. In one configuration, the fluid may be a refrigerant, whereby coil 20 receives high-pressure vapor refrigerant from the compressor assembly 16 and converts the high-pressure vapor refrigerant from the vapor state to a liquid state prior to providing the expansion device and evaporator with liquid refrigerant via the outlet 30.

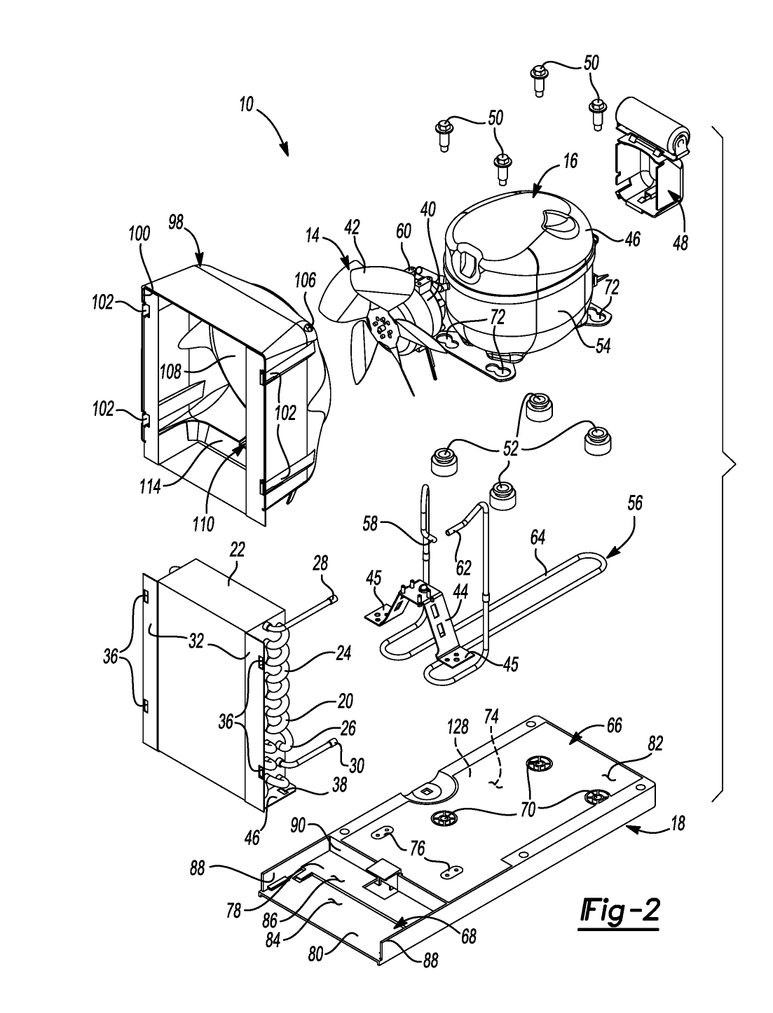

The housing 22 generally surrounds at least a portion of the tube 24 and may include a pair of sidewalls 32 and a pair of bottom brackets 34. The sidewalls 32 may extend along a length of the housing 22 and may each include at least one attachment aperture 36. The bottom brackets 34 may extend substantially perpendicular to the sidewalls 32, as shown in FIG. 2, and may similarly include at least one attachment aperture 38.

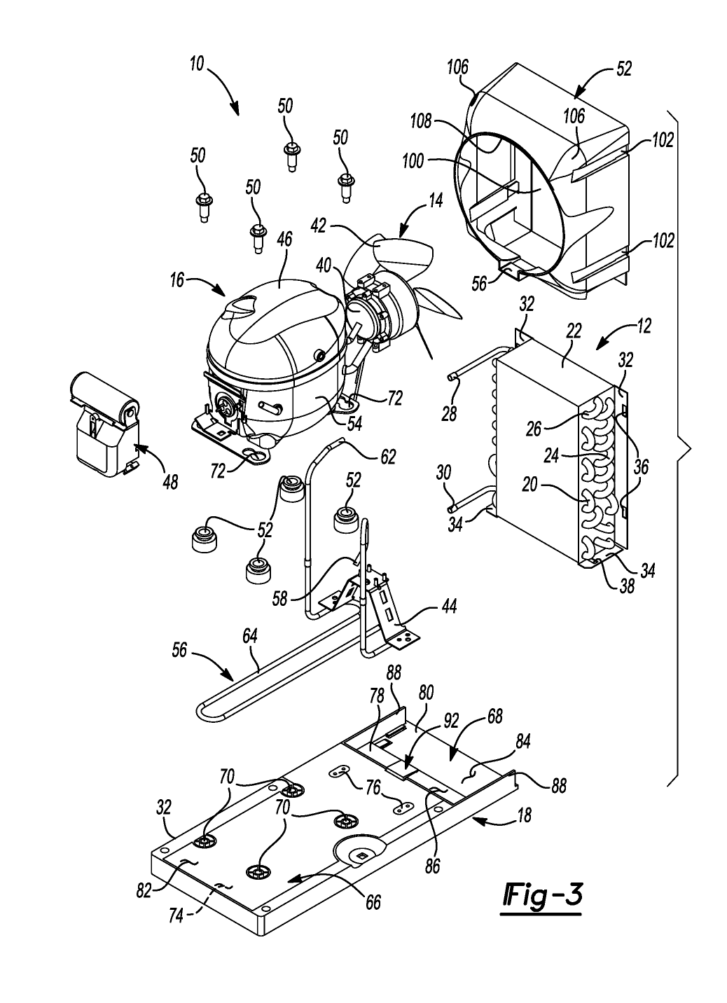

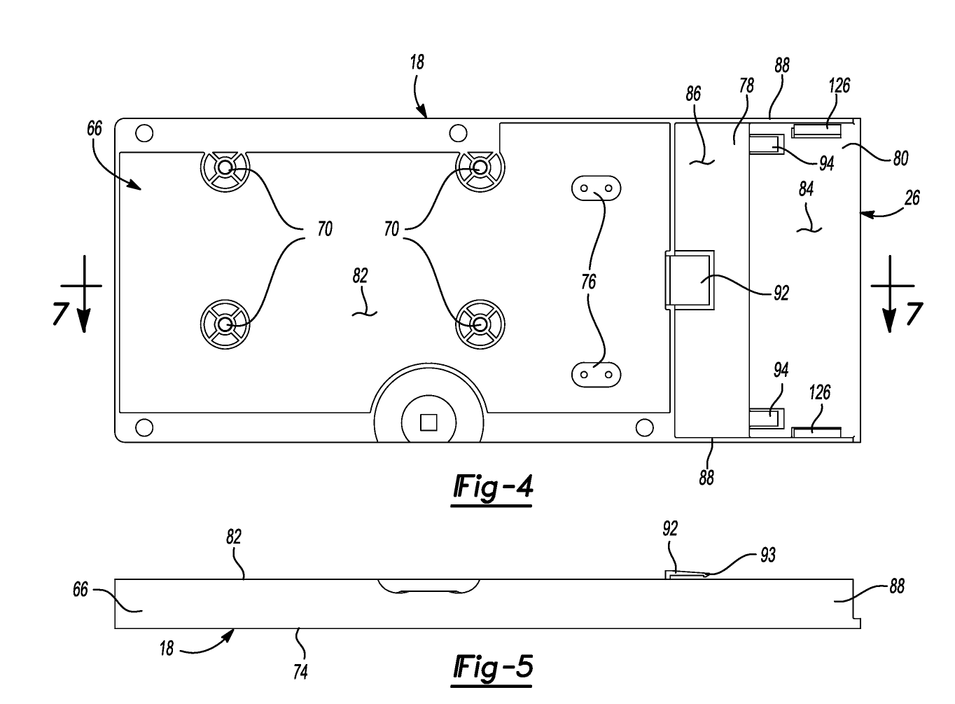

With particular reference to FIGS. 2 and 3, the fan assembly 14 is shown to include a motor 40, a fan 42, and a mounting bracket 44. The fan 42 may include a series of blades 43 and may be selectively driven by the motor 40 to impart a fluid force on the condenser assembly 12. Imparting a fluid force on the condenser assembly 12 draws ambient air generally into the condensing unit 10 and through the coil 20. Drawing ambient air through the coil 20 of the condenser assembly 12 allows the coil 20 to reject heat from high-pressure vapor refrigerant disposed generally within the tubing 24 of the coil 20 and convert the high-pressure vapor refrigerant from a vapor to a liquid prior to the refrigerant reaching the evaporator. The mounting bracket 44 may position the motor 40 and fan 42 of the fan assembly 14 relative to the coil 20 of the condenser assembly 12 to optimize air flow through the coil 20 and may provide an interface for attaching the motor 40 and fan 42 to the support base 18.

The compressor assembly 16 may circulate the refrigerant within the condensing unit 10 and generally from the condensing unit 10 to the evaporator. The compressor assembly 16 may include a compressor 46 and a controller 48 that controls operation of the compressor 46. The compressor 46 may be fixedly attached to the support base 18 via a series of fasteners 50 and a series of compressor mounts 52. The compressor mounts 52 may be formed of an elastomeric material such as, for example, rubber, and may absorb vibration caused by operation of the compressor 46 to prevent vibrational noise and/or damage to the compressor 46 and controller 48.

The controller 48 may control operation of the compressor 46 to control circulation of refrigerant within the condensing unit 10 and between the condensing unit 10 and the evaporator. In one configuration, the controller 48 may be mounted to an exterior shell 54 of the compressor 46 to place the controller 48 in close proximity to the compressor 46. While the controller 48 is shown and described as being attached to the shell 54 of the compressor 46, the controller 48 could alternatively be remotely located from the compressor 46 and/or the condensing unit 10.

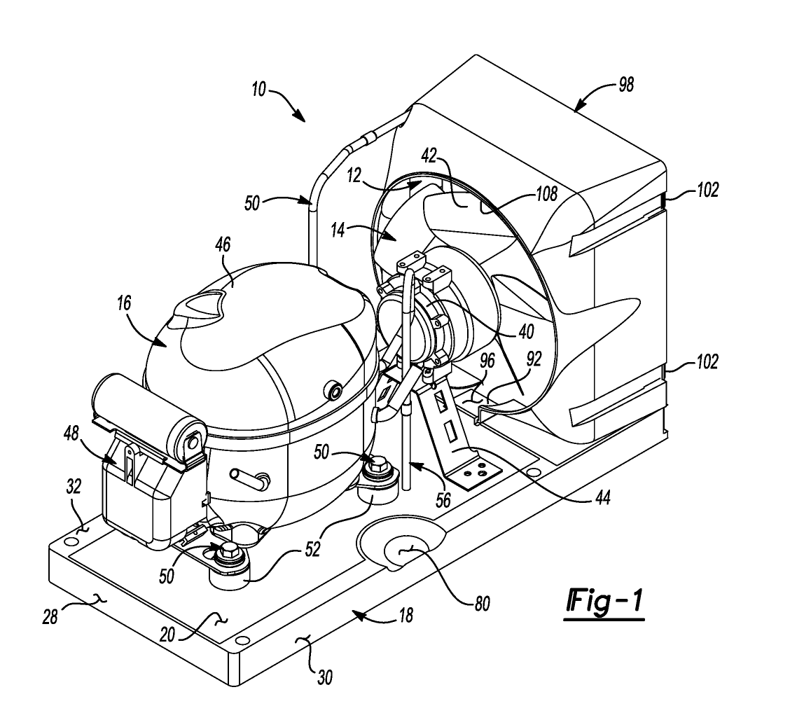

As shown in FIGS. 1 and 2, the compressor 46 may be fluidly coupled to the coil 20 of the condenser assembly 12 via tubing 56. The tubing 56 may include a first end 58 fluidly coupled to a discharge port 60 of the compressor 46 and a second end fluidly coupled to the inlet 28 of the coil 20. The tubing 56 may include a bottom portion 64 extending generally between the first end 58 and the second end 62 and may cooperate with the support base 18 to increase the ability of the condenser assembly 12 in converting high-pressure vapor refrigerant into liquid refrigerant, as will be described further below.

The support base 18 may support the condenser assembly 12, fan assembly 14, and compressor assembly 16 to allow the condenser assembly 12, fan assembly 14, and compressor assembly 16 to be packaged and installed as a single unit. The support base 18 may extend generally under each of the condenser assembly 12, fan assembly 14, and compressor assembly 16 and may include a generally rectangular shape having a main body 66 disposed adjacent to a recess 68. The main body 66 may support the fan assembly 14 and compressor assembly 16 while the recess 68 may support the condenser assembly 12 generally adjacent to the fan assembly 14 (FIG. 1).

The main body 66 may include a series of threaded apertures 70 that matingly receive the fasteners 50 of the compressor assembly 16 to fixedly attach the compressor 46 to the main body 66 of the support base 18. Specifically, the fasteners 50 may be inserted through mounting feet 72 of the compressor 46 and through the compressor mounts 52 prior to threadably engaging respective threaded apertures 70 of the support base 18. Once the fasteners 50 are threadably engaged with the threaded apertures 70 of the main body 66, the compressor 46 is fixed to the main body 66 of the support base 18. While the main body 66 is described and shown as including threaded apertures 70, the main body 66 may alternatively include through bores, whereby the fasteners 50 are inserted through the bores and matingly receive a mechanical fastener such as, for example, a nut on a bottom surface 74 of the main body 66.

In addition to the threaded apertures 70, the main body 66 may also include a series of attachment apertures 76 that matingly receive fasteners (not shown) that secure the mounting bracket 44 of the fan assembly 14 to the main body 66. As with the threaded apertures 70, the attachment aperture 76 may be threaded apertures or through bores that cooperate with fasteners to fixedly attach the mounting bracket 44 to the main body 66.

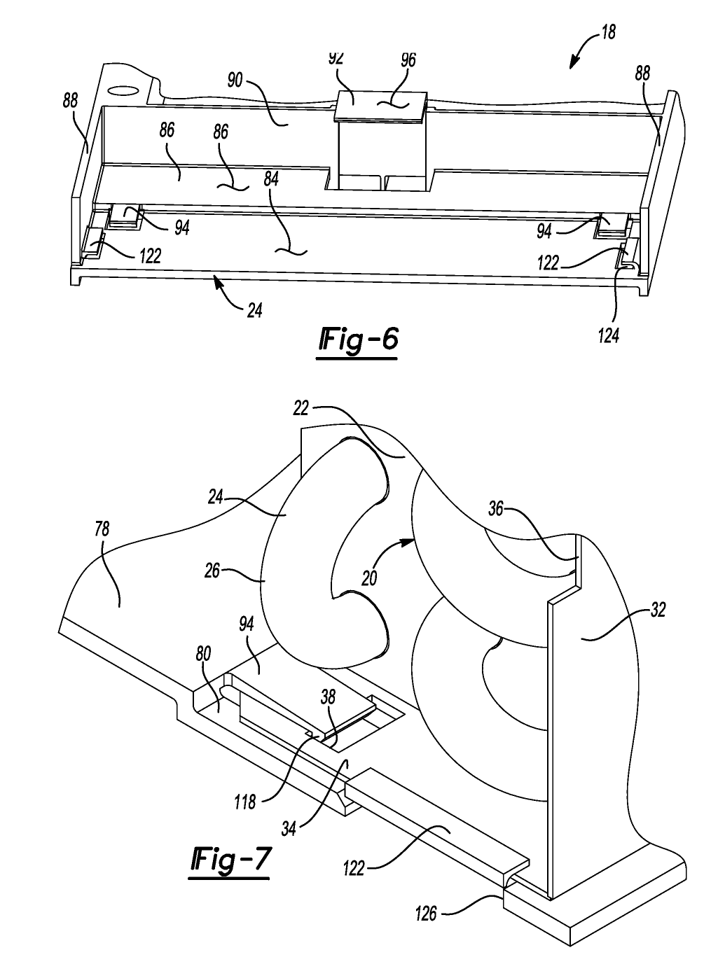

As shown in FIGS. 2 and 3, the recess 68 is disposed adjacent to the main body 66 and may include a first stepped portion 78 and a second stepped portion 80. The first stepped portion 78 may be recessed from a top surface 82 of the main body 66 and may be disposed generally between the main body 66 and the second stepped portion 80. The second stepped portion 80 may similarly be recessed from the top surface 82 of the main body 66 and may also be recessed from a top surface 86 of the first stepped portion 78 (FIG. 6). As described, a top surface 84 of the second stepped portion 80 may be recessed from the top surface 82 of the main body 66 a greater distance than the top surface 86 the first stepped portion 78. As such, the top surface 86 of the first stepped portion 78 is recessed from the top surface 84 of the main body 66 but to a lesser extent than is the top surface 84 of the second stepped portion 80.

The first stepped portion 78 and the second stepped portion 80 may be at least partially bounded by a pair of sidewalls 88 and a back wall 90. The sidewalls 88 may extend substantially perpendicular to the top surface 84 of the second stepped portion 80 and to the top surface 86 of the first stepped portion 78 and may be positioned on opposite ends of the support base 18. The back wall 90 may extend generally between the sidewalls 88 such that the back wall 90 is substantially perpendicular to each of the sidewalls 88 and is substantially perpendicular to the top surface 86 of the first stepped portion 78. The back wall 90 may be disposed at a junction of the main body 66 and the recess 68 (FIGS. 2 and 3).

With particular reference to FIG. 6, the first stepped portion 78 may include a retention feature 92 and a pair of locking tabs 94, whereby the retention feature 92 may extend over the first stepped portion 78 such that the retention feature 92 is cantilevered from the back wall 90 and is spaced apart from the top surface 86 of the first stepped portion 78. The retention feature 92 may be disposed generally between the sidewalls 88 and may be spaced apart from the top surface 86 of the first stepped portion 78. In one configuration, the retention feature 92 may include a top surface 96 that extends above the top surface 86 of the first stepped portion 78 and above the top surface 82 of the main body 66. In another configuration, the top surface 96 of the retention feature 92 may be generally flush with the top surface 82 of the main body 66.

The retention feature 92 may position and retain a shroud 98 (FIG. 9) such that the shroud 98 is fixed to the support base 18 and is disposed generally above the first stepped portion 78. The shroud 98 may rotatably receive the fan 42 of the fan assembly 14 and may include an opening 100 that directs ambient air into the shroud 98 and generally toward the coil 20 of the condenser assembly 12.

The shroud 98 may include a series of retention features 102 that extend from sidewalls 104 of the shroud 98 and may include generally rounded corners 106 on a back portion of the shroud 98 generally opposite from the opening 100. The shroud 98 may also include a fan opening 108 disposed adjacent to the rounded corners 106 and positioned on opposite side of the shroud 98 from the opening 100. A recess 110 may be in fluid communication with the fan opening 108 for matingly receiving the retention feature 92 of the support base 18 to fixedly attach the shroud 98 to the support base 18. The recess 110 may include a notch 112 (FIG. 9) that receives the retention feature 92 to prevent removal of the shroud 98 from the support base 18.

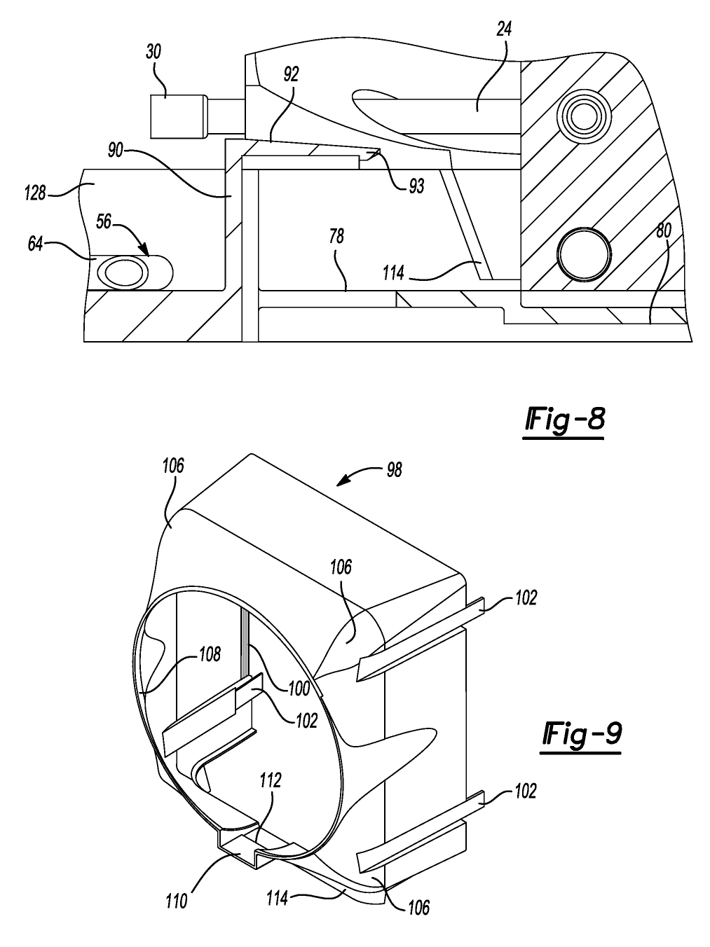

In one configuration, the retention feature 92 may include a tab 93 disposed on a distal end thereof that is matingly received by the notch 112 of the recess 110. While the recess 110 is described as including a notch 112, the tab 93 could alternatively be received over and within the recess 110 such that the tab 93 engages an edge 95 (FIG. 8) of the shroud 98 disposed adjacent to the recess 110. Engagement between the tab 93 and the shroud 98 prevents removal of the shroud 98 from the support base 18.

The shroud 98 may also include an air dam 114 (FIGS. 8 and 9) disposed on a bottom portion thereof to direct air towards the coil 20. By providing an air dam 114 generally at an interface of the shroud 98 and the top surface 86 of the first stepped portion 78, air is prevented from passing between the shroud 98 and the first stepped portion 78 and is directed towards the coil 20. Directing all of the air drawn by the fan 42 generally through the coil 20 improves the efficiency of the coil in converting vapor refrigerant from the vapor state to a liquid state prior to the refrigerant reaching the evaporator.

Referring to FIGS. 6 and 7, the locking tabs 94 may be cantilevered away from the first stepped portion 78 generally towards the second stepped portion 80. Because the top surface 86 of the first stepped portion 78 is disposed generally above the top surface 84 of the second stepped portion 80, the locking tabs 94 are cantilevered away from the first stepped portion 78 and may extend generally above the top surface 84 of the second stepped portion 80. The locking tabs 94 may be disposed over recesses 116 formed in the second stepped portion 80 to permit the locking tabs 94 to move relative to the second stepped portion 80 without actually contacting the second stepped portion 80. In one configuration, the tabs 94 may be formed from material removed from the second stepped portion 80 in forming the recesses 116.

The locking tabs 94 may include a retention feature 118 extending from a bottom portion of each locking tab 94 to retain the condenser assembly 12 within the recess 68 of the support base 18. Specifically, the retention feature 118 may be matingly received within the attachment apertures 38 formed through the bottom brackets 34 of the housing 22 to prevent removal of the housing 22 and, thus, the coil 20 from the support base 18 when the condenser assembly 12 is assembled to the support base 18.

The second stepped portion 80 may include a pair of projections 122 extending generally from the sidewalls 88. Each projection 122 may be spaced apart from the top surface 84 of the second stepped portion 80 such that a gap 124 exists generally between each projection 122 and the top surface 84 of the second stepped portion 80. In one configuration, the pair of recesses 126 are formed in the second stepped portion 80, whereby the material removed from the second stepped portion 80 is used to form the projections 122.

Assembly of the condensing unit 10 will be described in detail. The fan assembly 14 and compressor assembly 16 may be assembled to the support base 18 prior to or following assembly of the shroud 98 and condenser assembly 12 to the support base 18. While the fan assembly 14 and/or compressor assembly 16 may be assembled to the support base 18 prior to or following assembly of the shroud 98 and condenser assembly 12 to the support base 18, the fan assembly 14 and compressor assembly 16 will be described as being attached to the support base 18 prior to assembly of the condenser assembly 12 and shroud 98 to the support base 18.

The tubing 56 that fluidly couples the compressor 46 to the condenser assembly 12 and evaporator may be attached to the support base 18 prior to attachment of the fan assembly 14 and compressor assembly 16 to facilitate installation of the tubing 56.

The bottom portion 64 of the tubing 56 may be received generally within an interior space 128 (FIG. 8) of the support base 18. Positioning the bottom portion 64 of the tubing 56 within the interior space 128 of the support base 18 allows condensation to collect generally within the interior space 128 of the support base 18. Allowing condensation to collect within the interior space 128 of the support base 18 increases the overall efficiency of the condensing unit 10 in converting high-pressure vapor refrigerant into the liquid state by first cooling the discharge-pressure vapor refrigerant received from the discharge port 60 of the compressor 46 prior to the discharge-pressure vapor refrigerant reaching the coil 20. Lowering the temperature of the refrigerant prior to the refrigerant reaching the coil 20 reduces the amount of heat that must be extracted from the refrigerant via the coil 20 before the refrigerant changes phase from the vapor state to the liquid state and, therefore, improves the overall efficiency and operation of the condenser assembly 12.

Once the compressor assembly 16 is attached to the support base 18, the first end 58 of the tubing 56 may be fluidly coupled to the discharge port 60 of the compressor 46 by a suitable process such as, for example, brazing. The second end 62 of the tubing 56 may be positioned relative to the eventual position of the coil 20 but is not attached to the coil 20 until the coil 20 is attached to the support base 18.

The compressor assembly 16 may be attached to the support base 18 by inserting the fasteners 50 through the mounting feet 72 of the compressor 46, through the compressor mounts 52, and finally into the threaded apertures 70 of the support base 18. Similarly, fasteners (not shown) may be inserted through apertures 45 of the mounting bracket 44 to secure the mounting bracket 44 to the support base 18 via attachment aperture 76. Attaching the mounting bracket 44 to the support base 18 via interaction between the fasteners and the attachment apertures 76 of the support base 18 similarly attaches the motor 40 and fan 42 of the fan assembly 14 to the support base 18.

Once the fan assembly 14 and compressor assembly 16 are attached to the support base 18, the condenser assembly 12 and shroud 98 may be attached to the support base 18. The shroud 98 may be attached to the support base 18 prior to the condenser assembly 12 by positioning the shroud 98 relative to the recess 68 of the support base 18. Alternatively, the shroud 98 may be attached to the condenser assembly 12 prior to attaching the shroud 98 and condenser assembly 12 to the support base 18 together. While the shroud 98 and condenser assembly 12 may be attached to the support base 18 together as a subassembly, prior to attaching the condenser assembly 12 and shroud 98 to the support base 18, installation of the shroud 98 to the support base 18 will be described hereinafter as being performed prior to attachment of the condenser assembly 12 to the support base 18.

Once the shroud 98 is positioned generally between the side walls 88 of the recess 68, a force may be applied to the shroud 98 to slide the shroud 98 relative to the support base 18. The shroud 98 is moved a predetermined distance relative to the support base 18 until the recess 110 of the shroud 98 engages the retention feature 92.

At this point, the force applied to the shroud 98 causes a wall 99 (FIG. 8) of the shroud 98 that generally defines a portion of the recess 110 to apply a force on the retention feature 92 of the first stepped portion 78 to bend the retention feature 92 generally away from the recess 110. The retention feature 92 will remain in the bent position due to engagement between the tab 93 of the retention feature 92 and the wall 99 of the shroud 98 until the shroud 98 is moved into contact with or is a predetermined distance away from the back wall 90 of the support base 18. Once the shroud 98 is positioned relative to the back wall 90 of the support base 18, the tab 93 of the retention feature 92 engages the notch 112 of the recess 110 or, alternatively, the edge 95 (FIG. 8) of the shroud 98, to prevent removal of the shroud 98 from the support base 18. In one configuration, engagement between the retention feature 92 and the notch 112 or edge 95 of the shroud 98 is a snap fit, whereby the tab 93 of the retention feature 92 is snapped into the notch 112 or over the edge 95 of the shroud 98 once the shroud 98 is moved a predetermined distance relative to the support base 18 to prevent removal of the shroud 98 from the support base 18.

Once the shroud 98 is attached to the support base 18, the condenser assembly 12 may be attached to the support base 18. The condenser assembly 12 is first positioned relative to the recess 68 to allow the condenser assembly 12 to be positioned generally between the sidewalls 88. A force may be applied to the condenser assembly 12 to slide the condenser assembly 12 relative to the support base 18 such that the bottom brackets 34 of the condenser assembly 12 are slidably received generally within the gap 124 disposed between the projections 122 and the top surface 84 of the second stepped portion 80. The condenser assembly 12 is moved relative to the support base 18 until the bottom brackets 34 encounter the locking tabs 94 of the first stepped portion 78 (FIG. 7). At this point, the bottom brackets 34 a predetermined distance apply a force on the locking tabs 94 to bend the locking tabs 94 generally way from the bottom brackets 34. Upon sufficient movement of the bottom brackets 34 relative to the second stepped portion 80, the retention feature 118 of the locking tabs 94 will engage a respective attachment aperture 38 of the bottom brackets 34 to prevent removal of the condenser assembly 12 from the support base 18.

The predetermined distance the shroud 98 is moved relative to the support base 18 to engage the retention feature 92 maybe the same as the predetermined distance the bottom brackets 34 are moved relative the second stepped portion 80 to engage the retention feature 118 of the locking tabs 94. These first and second predetermined distances may also be different distances, or moved the same distance in different sequences relative each other depending on the order of assembly or assembly of the shroud 98 and condenser assembly 12 to the support base 18 at the same time.

When the locking tabs 94 are received within the attachment apertures 38 of the bottom brackets 34, and the bottom brackets 34 are generally disposed within the gap 124 disposed between the projections 122 and the top surface 84 of the second stepped portion 80, the condenser assembly 12 is properly positioned relative to the support base 18 and may not be removed from the support base 18 until the locking tabs 94 are released from the attachment apertures 38 of each bottom bracket 34. As with the shroud 98, engagement between the retention features 118 of the locking tabs 94 and the apertures 38 of the bottom brackets 34 may be a snap fit, whereby the retention features are snapped into a respective aperture 38 automatically when the condenser assembly 12 is moved a predetermined distance within the recess 68 and relative to the support base 18.

As described, the condenser assembly 12 is disposed generally above the top surface 84 of the second stepped portion 80. Because the condenser assembly 12 is slid into position in order to engage the locking tabs 94, the opening to the second stepped portion must be open to allow the condenser assembly 12 to be received within the recess 68. As such, once the condenser assembly 12 is attached to the support base 18, the coil 20 (i.e., proximate to the opening 100 of the shroud 98) is not restricted and air may freely enter the coil 20. Further, because the attachment locations of the condenser assembly 12 to the support base 18 are near a back portion of the condenser assembly 12 (i.e., locking tabs 94 proximate to the shroud 98), none of the retention features interfere with airflow into the coil 20.

Positioning the condenser assembly 12 relative to the support base 18 similarly positions the condenser assembly 12 relative to the shroud 98. As such, when the condenser assembly 12 is moved into position relative to the support base 18, the attachment apertures 36 of the sidewalls 32 are similarly positioned relative to the retention features 102 of the shroud 98. The retention features 102 may matingly engage the attachment apertures 36 of the condenser assembly 12 to fixedly attach the condenser assembly 12 to the shroud 98. Once the condenser assembly 12 is fully installed and attached to the support base 18 and shroud 98, the inlet 28 of the tube 24 may be fluidly coupled to the second end 62 of the tubing 56 by a suitable method such as, for example, brazing.

As described above, the condenser assembly 12 and shroud 98 are attached to the support base 18 via various snap-fit arrangements. As such, threadable fasteners and/or rivets are not required to retain the condenser assembly 12 or shroud 98 to the support base 18. Rather, positioning the condenser assembly 12 and shroud 98 in a predetermined position relative to the support base 18 automatically causes retention features 92, 94, 122 of the support base 18 to engage respective retention features 38 of the condenser assembly 12 and retention features 95, 102, 112 of the shroud 98 to attach the condenser assembly 12 and shroud 98 to the support base 18.

What is claimed is:

1. A condensing unit comprising:
a support base having a first retention feature and a second retention feature;
a shroud including a first locking feature receiving one of said first retention feature and said second retention feature to automatically attach said shroud to said support base when said shroud is moved a first predetermined distance relative to said support base; and
a heat exchanger including at least one second locking feature receiving the other of said first locking feature and said second locking feature to automatically attach said heat exchanger to said support base when said heat exchanger is moved a second predetermined distance relative to said support base.

2. The condensing unit of claim 1, wherein at least one of said first retention feature and said second retention feature includes a locking tab.

3. The condensing unit of claim 1, wherein at least one of said first retention feature and said second retention feature is integrally formed with said support base.

4. The condensing unit of claim 1, wherein at least one of said first retention feature and said second retention feature are formed from the same material as said support base.

5. The condensing unit of claim 1, wherein at least one of said first retention feature and said second retention feature are formed from a flexible material and are movable between a relaxed state and an engaged state in response to at least one of movement of said shroud said first predetermined distance relative to said support base or movement of said heat exchanger said second predetermined distance relative to said support base.

6. The condensing unit of claim 1, wherein engagement between at least one of said first retention feature and said first locking feature and engagement between said second retention feature and said second locking feature includes a snap fit.

7. The condensing unit of claim 1, wherein said support base includes a third retention feature.

8. The condensing unit of claim 7, wherein said heat exchanger includes a third locking feature operable to engage said third retention feature when said heat exchanger is moved said second predetermined distance relative to said support base to secure said heat exchanger to said support base.

9. The condensing unit of claim 8, wherein at least one of said second retention feature and said third retention feature are in slidable engagement with said second locking feature and said third locking feature, respectively.

10. The condensing unit of claim 1, wherein said heat exchanger is a condenser.

11. The condensing unit of claim 1, wherein said first predetermined distance is approximately the same as said second predetermined distance.

12. A condensing unit comprising:
a support base having a first retention feature and a second retention feature;
a shroud including a first locking feature receiving said first retention feature in a snap-fit engagement to attach said shroud to said support base; and
a heat exchanger including at least one second locking feature receiving said second retention feature in a snap-fit engagement to attach said heat exchanger to said support base.

13. The condensing unit of claim 12, wherein said support base includes a third retention feature and said heat exchanger includes a third locking feature, said third retention feature engaging said third locking feature when said second locking feature receives said second retention feature to position said heat exchanger relative to said support base.

14. The condensing unit of claim 13, wherein said third locking feature is in slidable engagement with said third retention feature.

15. The condensing unit of claim 12, wherein at least one of said first retention feature and said second retention feature are integrally formed with said support base.

16. The condensing unit of claim 12, wherein at least one of said first retention feature and said second retention feature are formed of the same material.

17. The condensing unit of claim 12, wherein at least one of said first retention feature and said second retention feature are formed from a flexible material and are movable between a relaxed state and an engaged state in response to at least one of movement of said shroud or movement of said heat exchanger a predetermined distance relative to said support base.

18. The condensing unit of claim 12, wherein said heat exchanger is a condenser.

19. The condensing unit of claim 12, wherein said heat exchanger includes a retention element operable to engage a retention element of said shroud to attach said shroud to said heat exchanger.

20. A method comprising:
positioning a shroud relative to a support base;
moving said shroud relative to said support base until a first locking feature of said shroud engages a first retention feature of said support base to attach said shroud to said support base;
positioning a heat exchanger relative to said support base; and
moving said heat exchanger relative to said support base until a second locking feature of said heat exchanger engages a second retention feature of said support base to attach said heat exchanger to said support base.

21. The method of claim 20, wherein at least one of said moving said shroud and said moving said heat exchanger includes sliding.

22. The method of claim 20, wherein engaging said first retention feature and engaging said second retention feature includes bending at least one of said first retention feature and said second retention feature relative to said support base.

23. The method of claim 20, wherein engaging said first retention feature and engaging said second retention feature includes creating a snap-fit relationship between at least one of said first retention feature and said first locking feature and between said second retention feature and said second locking feature.

24. The method of claim 20, wherein engaging said first retention feature and engaging said second retention feature includes at least one of engaging a locking tab of said first retention feature with said first locking feature and engaging a locking tab of said second retention feature with said second locking feature.

25. The method of claim 20, further comprising engaging a third retention feature of said support base with a third retention feature of said heat exchanger.

26. The method of claim 25, wherein engaging said third retention feature with said third locking feature includes sliding said third locking feature relative to said third retention feature.

27. The method of claim 20, further comprising attaching said shroud to said heat exchanger prior to either of said shroud or said heat exchanger being attached to said support base.

28. The method of claim 20, further comprising attaching said shroud to said heat exchanger after at least one of said shroud and said heat exchanger are attached to said support base.
